(19) United States
(12) Patent Application Publication
(10) Pub. No.: US 2021/0380016 A1
(43) Pub. Date: Dec. 9, 2021

(54) DELIVERY SYSTEM BETWEEN DRONE AND VEHICLE AND METHOD FOR CONTROLLING THE SAME

(71) Applicants: Hyundai Motor Company, Seoul (KR); Kia Motors Corporation, Seoul (KR)

(72) Inventors: Dong Eun Cha, Hwaseong (KR); Jin Ho Hwang, Cheonan (KR); Sang Heon Lee, Seoul (KR)

(21) Appl. No.: 17/029,761

(22) Filed: Sep. 23, 2020

(30) Foreign Application Priority Data
Jun. 9, 2020 (KR) 10-2020-0069757

(51) Int. Cl. B60L 53/80; B64C 39/02; H04W 12/06; H04W 4/40

(52) U.S. Cl. CPC B60L 53/80; B64C 39/024; B64C 2201/042; H04W 4/40; B64C 2201/128; H04W 12/06

(57) ABSTRACT

A delivery system between a drone and a vehicle and a method for controlling the same are provided. The delivery system includes a roof carrier where a delivery object is exchanged between the roof carrier and a drone when an upper door is opened. A controller performs authentication of the drone, and opens the upper door of the roof carrier when the drone is authenticated. The controller operates a loading part to load the delivery object received from the drone thereon or unload the delivery object to be delivered to the drone therefrom.

### CROSS REFERENCE TO RELATED APPLICATION

The present application claims priority to Korean Patent Application No. 10-2020-0069757, filed on Jun. 9, 2020, the entire contents of which is incorporated herein for all purposes by this reference.

### BACKGROUND

### 1. Technical Field

The present disclosure relates to a delivery system between a drone and a vehicle and a method for controlling the same, the delivery system enabling an item to be delivered or returned from a vehicle via a drone; power of the vehicle and power of the drone to be complementary and charged with each other; and both the delivery and charging to be performed simultaneously and effectively.

### 2. Description of the Related Art

In a field of a vehicle, an autonomous vehicle has recently been developed, and the autonomous vehicle may increase convenience of movement and may also function as a living space in addition to a transportation device. In addition, as a drone has recently been used in various ways, an unmanned delivery system using the drone has been developed and is being operated experimentally. However, there has been no proposal for such a system performing an unmanned delivery to a vehicle using a drone or a concept of integrating the vehicle and the drone and exchanging power therebetween.

The contents described as the related art have been provided merely to assist in understanding the background of the present disclosure and should not be considered as corresponding to the related art known to those skilled in the art.

### SUMMARY

An object of the present disclosure is to provide a delivery system between a drone and a vehicle and a method for controlling the same, the delivery system enabling an item to be delivered or returned from a vehicle via a drone; power of the vehicle and power of the drone to be complementary and charged with each other; and both the delivery and charging to be performed simultaneously and effectively.

According to an exemplary embodiment of the present disclosure, a delivery system between a drone and a vehicle may include: a roof carrier positioned on a roof of a vehicle and loading a delivery object therein, having an upper door capable of being opened and closed t an upper portion thereof, and where the delivery object may be exchanged between the roof carrier and a drone when the upper door is opened; a loading part positioned in the roof carrier and loading the delivery object thereon or unloading the delivery object therefrom; and a controller configured to perform authentication of the drone, and operate the upper door of the roof carrier to be opened when the drone is authenticated and the loading part to load the delivery object received from the drone thereon or to unload the delivery object to be delivered to the drone therefrom.

The roof carrier may have a lower door positioned beneath thereof, and when the lower door is opened, a delivery object may be exchanged between the roof carrier and an interior space of the vehicle. When a delivery object in the interior space of the vehicle is delivered to the drone, the controller may be configured to operate the lower door beneath the roof carrier to be opened, when the delivery object in the interior space of the vehicle is loaded into the roof carrier, the controller may be configured to operate the loading part to load the delivery object thereon, and when the drone is authenticated, the controller may be configured to operate the upper door of the roof carrier to be opened and the loading part to unload the delivery object to be delivered to the drone therefrom.

When the delivery object of the drone requires delivery to the interior space of the vehicle, if the drone is authenticated, the controller may be configured to operate the upper door of the roof carrier to be opened, the loading part to load the delivery object received from the drone thereon, the lower door of the roof carrier to be opened and the loading part to unload the delivery object therefrom, for the delivery object to be delivered to the interior space of the vehicle. The delivery object may include a replaceable battery, and when connected to the vehicle, the replaceable battery may provide driving energy to the vehicle or be charged from the vehicle.

When the replaceable battery positioned in the vehicle requires replacement, the controller may be configured to load the replaceable battery in the vehicle into the roof carrier, and load a replaceable battery of the drone supplied from the drone into the roof carrier and then to be unloaded into the interior space of the vehicle. The controller may be configured to unload the replaceable battery of the vehicle loaded in the roof carrier into the drone. When connected to the drone, the replaceable battery may provide driving energy to the drone or be charged from the drone.

The controller may be configured to compare charge amount of the replaceable battery connected to the drone and charge amount of the replaceable battery connected to the vehicle, and may be configured to exchange the replaceable battery of the drone and the replaceable battery of the vehicle with each other when the charge amount of the replaceable battery connected to the vehicle is less than the charge amount of the replaceable battery connected to the drone. Additionally, the controller may be configured to compare the charge amount of the replaceable battery connected to the drone and the charge amount of the replaceable battery connected to the vehicle, and adjust cost settlement to be performed based on difference in the charge amount.

According to another exemplary embodiment of the present disclosure, a method for controlling the delivery system between a drone and a vehicle as described above may include: performing authentication by the controller and the drone; opening the upper door of the roof carrier when the drone is authenticated; and loading the delivery object received from the drone or unloading the delivery object to be delivered to the drone, by the loading part of the roof carrier. The delivery object may include a replaceable battery, and the method for controlling the delivery system between a drone and a vehicle may further include: determining a charge amount of an entire battery of the vehicle and a charge amount of the replaceable battery of the drone; and performing cost payment adjusted by a controller when the replaceable battery needs to be supplied to the vehicle from the drone.

The method for controlling the delivery system between a drone and a vehicle may further include performing cost settlement adjusted by the controller when the replaceable battery of the vehicle and the replaceable battery of the drone are exchanged with each other. Additionally, the method for controlling the delivery system between a drone and a vehicle may include performing cost collection adjusted by the controller when the replaceable battery needs to be supplied to the drone from the vehicle.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is a view showing a delivery system between a drone and a vehicle according to an exemplary embodiment of the present disclosure.

FIG. 2 is a flow chart of a method for controlling the delivery system between a drone and a vehicle according to an exemplary embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Furthermore, control logic of the present disclosure may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

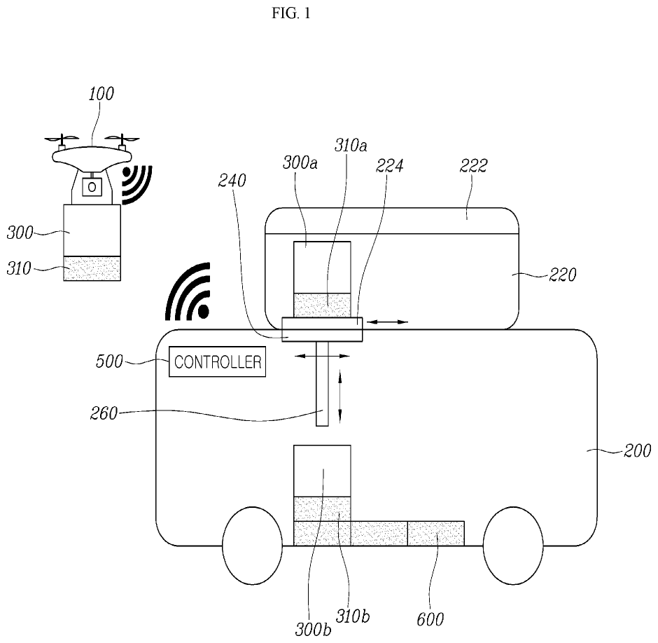

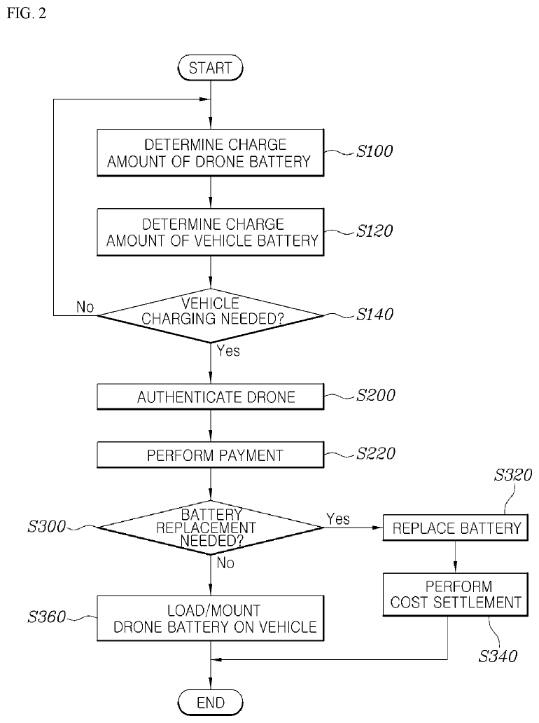

Hereinafter, a delivery system between a drone and a vehicle and a method for controlling the same according to exemplary embodiments of the present disclosure are described with reference to the accompanying drawings. FIG. 1 is a view showing a delivery system between a drone and a vehicle according to an exemplary embodiment of the present disclosure; and FIG. 2 is a flow chart of a method for controlling the delivery system between a drone and a vehicle according to an exemplary embodiment of the present disclosure.

The delivery system between a drone and a vehicle according to the present disclosure may include: a roof carrier 220 positioned on a roof of a vehicle 200 and loading a delivery object 300 therein, having an upper door 222 capable of being opened and closed at an upper portion thereon, and where the delivery object 300 may be exchanged between the roof carrier 220 and a drone 100 when the upper door 222 is opened; a loading part 224 positioned in the roof carrier 220 and loading the delivery object 300 thereon or unloading the delivery object 300 therefrom; and a controller 500 configured to perform authentication of the drone 100, and operate the upper door 222 of the roof carrier 220 to be opened when the drone 100 is authenticated and the loading part 224 to load the delivery object 300 received from the drone 100 thereon or to unload the delivery object 300 to be delivered to the drone 100 therefrom.

The present disclosure proposes a method of performing delivery to the vehicle through the drone and simultaneously exchanging power between the drone and the vehicle. In particular, the delivery object 300 may be loaded on the drone 100. The delivery object 300 may be implemented in various manners, and may be implemented using a concept of a standardized carrier for exchanging charged power between the drone and the vehicle 200 or for convenience of management. Therefore, the delivery object may have a form of a standardized box, may load an item to be delivered therein, and may preferably have a battery built in one side thereof.

In addition, the drone 100 may be configured to communicate directly with the vehicle 200 and also communicate with an external server (not shown) to perform authentication of the vehicle 200, and may be operated based on server instructions. The roof carrier 220 may be positioned in the vehicle 200. The roof carrier 220 may be formed integrally with the roof of the vehicle or may be formed separately from and mounted on the roof of the vehicle. In case of the shown exemplary embodiment, the roof carrier 220 is formed integrally with the roof of the vehicle 200.

Further, the roof carrier 220 may be positioned on the roof of the vehicle and load a delivery object 300a therein. In addition, the upper door 222 capable of being opened and closed may be formed on an upper portion of the roof carrier 220. When the upper door 222 is opened, the delivery object 300a may be exchanged between the roof carrier 220 and the drone 100. As shown in the drawings, the upper door 222 of the roof carrier 220 may be opened and closed by a pivoting motion, and when the upper door 222 is opened, an interior space of the roof carrier 220 may be exposed upward. Accordingly, the delivery object 300a may be exchanged between the roof carrier 220 and the drone 100.

In addition, the loading part 224 may be positioned in the roof carrier 220. The loading part 224 may be positioned on a bottom surface of roof carrier 220 to perform locking of the delivery object 300a when the delivery object 300a is loaded in the roof carrier 220. The locking may be released when the delivery object 300a is unloaded into the drone 100 or an interior space of the vehicle 200. In addition, the loading part 224 may also slide back and forth in a state of performing the locking. Various locking mechanisms may be applied to the loading part 224. The locking mechanism may use a conventional method common in a machinery field and a detailed description thereof is thus omitted.

The controller 500 may be positioned within the vehicle. In particular, the controller 500 may be configured to perform the authentication of the drone 100, operate the upper door 222 of the roof carrier 220 to be opened when the drone 100 is authenticated, and operate the loading part 224 to load the delivery object 300a received from the drone 100 thereon or unload the delivery object 300a to be delivered to the drone 100 therefrom.

The controller according to an exemplary embodiment of the present disclosure may be implemented by an algorithm configured to execute operations of various components of the vehicle, a nonvolatile memory (not shown) configured to store data on software instructions reproducing the algorithm, and a processor (not shown) configured to perform operations described below using the data stored in the memory. Particularly, the memory and the processor may be implemented as separate chips. Alternatively, the memory and processor may be implemented as a single chip integrated with each other, and the processor may take a form of one or more processors.

In addition, the controller 500 may be equipped with a wireless communication terminal to communicate with the drone 100 or the external server. The controller 500 may utilize the communication terminal, processing and memory functions to receive information regarding the drone 100 scheduled in advance to approach the vehicle 200 from the drone 100 or the server, and perform the authentication of the drone 100 by exchanging the information with the drone 100.

In response to authenticating the drone 100, the controller 500 may be configured to operate the roof carrier 220 to be opened, and thus control the delivery object 300 to be received from the drone 100 or the delivery object 300 to be delivered to the drone 100. In addition, the controller 500 may be configured to simultaneously operate the loading part 224 to load the delivered object thereon or unload the object to be delivered therefrom. When the loading or the unloading is completed, the controller 500 may be configured to operate the roof carrier 220 to be closed, and thus control an additional work such as delivering the delivered object 300a to the interior space of the vehicle to be performed.

The roof carrier 220 may include a sliding lower door 240 positioned beneath thereof. If the roof carrier 220 may be installed above and spaced apart from the roof of the vehicle, when the lower door 240 is opened, a sunroof (not shown) in the roof of the vehicle 200 may also need to be opened together. In addition, when the lower door 240 is opened, the delivery object 300a may be exchanged between the roof carrier 220 and the interior space of the vehicle 200. A transport mechanism 260 sliding up and down (e.g., vertically) may be installed in the interior space of the vehicle for the exchange of the object. The transport mechanism 260 may grip a delivery object 300b, and slide vertically to transport the object between the roof carrier 220 and the interior space of the vehicle 200.

Meanwhile, when the delivery object 300b in the interior space of the vehicle needs to be delivered to the drone 100, the controller 500 may be configured to operate the lower door 240 beneath the roof carrier 220 to be opened and the delivery object 300b in the vehicle to be moved toward the roof via the transport mechanism 260. When the delivery object 300b in the interior space of the vehicle is loaded into the roof carrier 220, the controller 500 may be configured to operate the loading part 224 to load the delivery object 300a thereon, and when the drone 100 approaching the vehicle 200 is authenticated, the controller 500 may be configured to operate the upper door 222 of the roof carrier 220 to be opened and the loading part to unload the delivery object 300a to be delivered to the drone 100 therefrom. Accordingly, the drone 100 may grip the delivery object 300a unloaded from the roof carrier 220 and fly to deliver the object from the vehicle to a desired destination.

In addition, when the delivery object 300 of the drone 100 needs to be delivered to the interior space of the vehicle 200, if the drone 100 approaches the vehicle 200 and is authenticated, the controller 500 may be configured to operate the upper door 222 of the roof carrier 220 to be opened and the loading part 224 to load the delivery object 300a received from the drone 100 thereon. Then, the controller 500 may be configured to operate the upper door 222 of the roof carrier 220 to be closed, the lower door 240 to be opened and the loading part 224 to unload the delivery object 300a therefrom, for the delivery object 300a to be delivered to the interior space of the vehicle 200 through the transport mechanism 260.

Further, it may also be possible to exchange power between the drone 100 and the vehicle 200. Accordingly, the delivery object 300 may include a replaceable battery 310. In other words, the delivery object 300 may have the form of a standardized box, and have the battery built into the box. Therefore, when the delivery object 300b is positioned in the interior space of the vehicle, the battery thereof may be electrically connected to a high voltage battery 600 positioned within the vehicle and operating as a battery 310b of the vehicle. When the delivery object 300 is connected to the drone 100, the battery thereof may operate as the battery 310 that provides the drone 100 with the power. Therefore, when the delivery object 300 is exchanged between the drone 100 and the vehicle 200, the power may be exchanged between the drone 100 and the vehicle 200. In addition, the power may be exchanged via the delivery object 300, and the object and the power may thus be simultaneously exchanged between the drone 100 and the vehicle 200.

In particular, when connected to the vehicle 200, the replaceable battery 310b may provide driving energy to the vehicle 200 or be charged from the vehicle (e.g., from the vehicle battery). When the vehicle 200 has insufficient power, the controller 500 may be configured to determine that the replaceable battery 310b positioned in the vehicle 200 requires replacement. Particularly, the controller 500 may be configured to load the replaceable battery 310b in the vehicle into the roof carrier 220, the loading part 224 to slide to the side and then the replaceable battery 310 to be supplied from the drone 100 and loaded into the roof carrier 220. Then, the controller 500 may be configured to unload a replaceable battery 310a supplied from the drone 100 into the interior space of the vehicle 200 through the transport mechanism 260.

In addition, the controller 500 may be configured to unload the replaceable battery 310a of the vehicle 200 loaded in the roof carrier 220 into the drone 100. In particular, the drone 100 may have insufficient power, and when connected to the drone 100, the replaceable battery 310 may provide driving energy to the drone 100 or may be charged from the drone 100. In addition, the controller 500 may be configured to compare charge amount of the replaceable battery 310 connected to the drone 100 and a charge amount of the replaceable battery 310b connected to the vehicle 200, and may be configured to exchange the replaceable battery of the drone 100 and the replaceable battery of the vehicle 200 with each other when the charge amount of the replaceable battery 310b connected to the vehicle 200 is less than the charge amount of the replaceable battery 310 connected to the drone 100.

In other words, the controller 500 may be configured to receive information regarding the charge amount of the replaceable battery 310 connected to the drone 100 from the drone 100, compare this information with information regarding the charge amount of the replaceable battery 310b connected to the vehicle 200, and operate the two replaceable batteries to be exchanged with each other when necessary. In addition, the controller 500 may be configured to compare the charge amount of the replaceable battery 310 connected to the drone 100 and the charge amount of the replaceable battery 310b connected to the vehicle 200, and adjust cost settlement to be performed based on difference in the charge amount. When the power of the vehicle 200 is supplied to the drone 100, it may also be possible to receive online payment from a drone company, and when the power is supplied to the vehicle 200, it may also be possible to pay the corresponding cost to the drone company.

FIG. 2 is a flow chart of a method for controlling the delivery system between a drone and a vehicle according to an exemplary embodiment of the present disclosure. The method for controlling the delivery system between a drone and a vehicle of the present disclosure may include: performing authentication by the controller and the drone (S200); opening the upper door of the roof carrier (S360) in response to authenticating the drone; and loading the delivery object received from the drone or unloading the delivery object to be delivered to the drone (S360), by the loading part of the roof carrier.

The method for controlling the delivery system between a drone and a vehicle, wherein the delivery object includes a replaceable battery, the method for controlling the delivery system between a drone and a vehicle may further include: determining charge amount of an entire battery of the vehicle (S100) and charge amount of the replaceable battery of the drone (S120); and performing cost payment (S220) adjusted by a controller when the replaceable battery needs to be supplied to the vehicle from the drone.

In addition, the method for controlling the delivery system between a drone and a vehicle may further include performing cost settlement (S340) adjusted by the controller when the replaceable battery of the vehicle and the replaceable battery of the drone are exchanged with each other. The method may further include performing cost collection adjusted by the controller when the replaceable battery needs to be supplied to the drone from the vehicle.

First, when the drone approaches the vehicle, the charge amount of the entire battery of the vehicle (S100) and the charge amount of the replaceable battery of the drone (S120) may be determined. Then, a controller and the drone may be configured to perform the authentication (S200) in response to determining that charging of the vehicle is needed (S140). When the authentication is completed, the controller may allow the cost payment (S220) to be performed to a server and the replaceable battery to be received from the drone (S300). In this process, if the delivery object is not supplied to the vehicle but exchanged between the drone and the vehicle each other, the replaceable battery used in the vehicle may be returned to the drone, and processes (S360, S320 and S340) of the cost settlement may thus be needed. In addition, if the vehicle does not require charging and the drone has insufficient power, the batteries may be exchanged with each other and the controller of the vehicle may allow a cost to be received from the server.

According to the delivery system between a vehicle and a drone of the present disclosure and a method for controlling the same, an item may be delivered or returned from a vehicle via a drone, power of the vehicle and power of the drone may be complementary and charged with each other, and both the delivery and charging may be performed simultaneously and effectively.

Although the present disclosure is shown and described with respect to the specific exemplary embodiments, it is obvious to those skilled in the art that the present disclosure may be variously modified and altered without departing from the spirit and scope of the present disclosure as defined by the following claims.

What is claimed is:

1. A delivery system between a drone and a vehicle, comprising:
a roof carrier positioned on a roof of the vehicle and in which a delivery object is loaded, wherein the roof carrier includes an upper door capable of being opened and closed at an upper portion thereof, and wherein the delivery object is exchanged between the roof carrier and the drone when the upper door is opened;
a loading part positioned in the roof carrier and configured to load the delivery object thereon or unload the delivery object therefrom; and
a controller configured to perform authentication of the drone, and operate the upper door of the roof carrier to be opened in response to authenticating the and operate the loading part to load the delivery object received from the drone thereon or to unload the delivery object to be delivered to the drone therefrom.

2. The delivery system between a drone and a vehicle of claim 1, wherein the roof carrier includes a lower door positioned beneath thereof, and when the lower door is opened, a delivery object is exchanged between the roof carrier and an interior space of the vehicle.

3. The delivery system between a drone and a vehicle of claim 2, wherein:
when a delivery object in the interior space of the vehicle is to be delivered to the drone, the controller is configured to open the lower door beneath the roof carrier,
when the delivery object in the interior space of the vehicle is loaded into the roof carrier, the controller is configured to operate the loading part to load the delivery object thereon, and
in response to authenticating the drone, the controller is configured to open the upper door of the roof carrier and operate the loading part to unload the delivery object to be delivered to the drone therefrom.

4. The delivery system between a drone and a vehicle of claim 2, wherein when the delivery object of the drone is to be delivered to the interior space of the vehicle, and the drone is authenticated, the controller is configured to open the upper door of the roof carrier, operate the loading part to load the delivery object received from the drone thereon, open the lower door of the roof carrier and operate the loading part to unload the delivery object therefrom, for the delivery object to be delivered to the interior space of the vehicle.

5. The delivery system between a drone and a vehicle of claim 1, wherein the delivery object includes a replaceable battery, and when connected to the vehicle, the replaceable battery provides driving energy to the vehicle or is charged from the vehicle.

6. The delivery system between a drone and a vehicle of claim 5, wherein when the replaceable battery positioned in the vehicle is to be replaced, the controller is configured to load the replaceable battery in the vehicle into the roof carrier, and load a replaceable battery of the drone supplied from the drone into the roof carrier and then unload the replaceable battery of the drone into the interior space of the vehicle.

7. The delivery system between a drone and a vehicle of claim 6, wherein the controller is configured to unload the replaceable battery of the vehicle loaded in the roof carrier into the drone.

8. The delivery system between a drone and a vehicle of claim 5, wherein when connected to the drone, the replaceable battery provides driving energy to the drone or is charged from the drone.

9. The delivery system between a drone and a vehicle of claim 5, wherein the controller is configured to compare a charge amount of the replaceable battery connected to the drone and a charge amount of the replaceable battery connected to the vehicle, and exchange the replaceable battery of the drone and the replaceable battery of the vehicle with each other when the charge amount of the replaceable battery connected to the vehicle is less than the charge amount of the replaceable battery connected to the drone.

10. The delivery system between a drone and a vehicle of claim 5, wherein the controller is configured to compare the charge amount of the replaceable battery connected to the drone and the charge amount of the replaceable battery connected to the vehicle, and adjust cost settlement to be performed based on difference in the charge amount.

11. A method for controlling the delivery system between a drone and a vehicle of claim 1, comprising:
performing, by a controller, authentication and the drone;
opening, by the controller, the upper door of the roof carrier in response to authenticating the drone; and
loading, by the controller, the delivery object received from the drone or unloading the delivery object to be delivered to the drone, via the loading part of the roof carrier.

12. The method for controlling the delivery system of claim 11, wherein the delivery object includes a replaceable battery, and the method further comprises:
determining, by the controller, a charge amount of an entire battery of the vehicle and a charge amount of the replaceable battery of the drone; and
performing, by the controller, cost payment adjustment when the replaceable battery needs to be supplied to the vehicle from the drone.

13. The method for controlling the delivery system of claim 12, further comprising performing cost settlement adjusted by the controller when the replaceable battery of the vehicle and the replaceable battery of the drone are exchanged with each other.

14. The method for controlling the delivery system between a drone and a vehicle of claim 11, further comprising performing cost collection adjusted by the controller when the replaceable battery needs to be supplied to the drone from the vehicle.
